(19) United States
(12) Patent Application Publication
(10) Pub. No.: US 2025/0227477 A1
(43) Pub. Date: Jul. 10, 2025

(54) BLUETOOTH PAIRING USING A LIGHT SENSOR

(71) Applicant: QUALCOMM Incorporated, San Diego, CA (US)

(72) Inventor: Arnab Kumar DAS, Burdwan (IN)

(21) Appl. No.: 18/404,729

(22) Filed: Jan. 4, 2024

(51) Int. Cl. H04W 12/50; H04W 12/40

(52) U.S. Cl. CPC H04W 12/50; H04W 12/40

(57) ABSTRACT

This disclosure provides methods, components, devices and systems for Bluetooth pairing using a light sensor. A UE and a light-emitting device may perform a Bluetooth pairing procedure based on information transmitted via light output from the light-emitting device. The light-emitting device may generate encoded information such as encoded pairing information associated with the light-emitting device, encoded personal identification information of the light-emitting device, or both. The light-emitting device may transmit the encoded information by modulating light output. In some implementations, the UE may receive the encoded information via a sensor and may decode the encoded information to obtain pairing information, personal identification information associated with the light-emitting device, or both. After successfully completing this transmission and decoding, the UE and the light-emitting device may perform the Bluetooth pairing procedure based on the pairing information, the personal identification information, or both.

### TECHNICAL FIELD

This disclosure relates generally to wireless communication and, more specifically, to Bluetooth pairing using a light sensor. Specifically, this disclosure relates to a client device and a light-emitting device that may perform a Bluetooth pairing procedure based on information transmitted via light output from the light-emitting device.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a user equipment (UE). The method may include receiving, via a sensor at the UE, a signal including light output modulation of a light-emitting device, the signal including encoded pairing information, decoding the encoded pairing information of the signal to obtain pairing information associated with the light-emitting device, and performing, at the UE, a Bluetooth pairing procedure with the light-emitting device based on the pairing information.

Another innovative aspect of the subject matter described in this disclosure can be implemented in a UE for wireless communications. The UE may include a processing system that includes processor circuitry and memory circuitry that stores code. The processing system may be configured to cause the UE to receive, via a sensor at the UE, a signal including light output modulation of a light-emitting device, the signal including encoded pairing information, decode the encoded pairing information of the signal to obtain pairing information associated with the light-emitting device, and perform, at the UE, a Bluetooth pairing procedure with the light-emitting device based on the pairing information.

Another innovative aspect of the subject matter described in this disclosure can be implemented in another UE for wireless communications. The UE may include means for receiving, via a sensor at the UE, a signal including light output modulation of a light-emitting device, the signal including encoded pairing information, means for decoding the encoded pairing information of the signal to obtain pairing information associated with the light-emitting device, and means for performing, at the UE, a Bluetooth pairing procedure with the light-emitting device based on the pairing information.

Another innovative aspect of the subject matter described in this disclosure can be implemented in a non-transitory computer-readable medium storing code for wireless communications. The code may include instructions executable by one or more processors to receive, via a sensor at the UE, a signal including light output modulation of a light-emitting device, the signal including encoded pairing information, decode the encoded pairing information of the signal to obtain pairing information associated with the light-emitting device, and perform, at the UE, a Bluetooth pairing procedure with the light-emitting device based on the pairing information.

In some examples of the method, UEs, and non-transitory computer-readable medium described herein, the signal includes personal identification information associated with the light-emitting device and performing the Bluetooth pairing procedure with the light-emitting device may be based on the personal identification information.

In some examples of the method, UEs, and non-transitory computer-readable medium described herein, the personal identification information includes a personal identification number (PIN) or a passkey associated with the light emitting device.

In some examples of the method, UEs, and non-transitory computer-readable medium described herein, the signal further includes an on-off keying signal, a variable pulse position modulation signal, a color shift keying signal, or any combination thereof.

In some examples of the method, UEs, and non-transitory computer-readable medium described herein, receiving the signal may include operations, features, means, or instructions for detecting a unique pattern of changes in light intensity of the light output modulation via the sensor at the UE.

Another innovative aspect of the subject matter described in this disclosure can be implemented in a method for wireless communications by a light-emitting device. The method may include generating encoded pairing information associated with the light-emitting device, transmitting a signal including light output modulation of the light-emitting device, the signal including the encoded pairing information, and performing, at the light-emitting device, a Bluetooth pairing procedure with a UE based on the encoded pairing information.

Another innovative aspect of the subject matter described in this disclosure can be implemented in a light-emitting device for wireless communications. The light-emitting device may include a processing system that includes processor circuitry and memory circuitry that stores code. The processing system may be configured to cause the light-emitting device to generate encoded pairing information associated with the light-emitting device, transmit a signal including light output modulation of the light-emitting device, the signal including the encoded pairing information, and perform, at the light-emitting device, a Bluetooth pairing procedure with a UE based on the encoded pairing information.

Another innovative aspect of the subject matter described in this disclosure can be implemented in another light-emitting device for wireless communications. The light-emitting device may include means for generating encoded pairing information associated with the light-emitting device, means for transmitting a signal including light output modulation of the light-emitting device, the signal including the encoded pairing information, and means for performing, at the light-emitting device, a Bluetooth pairing procedure with a UE based on the encoded pairing information.

Another innovative aspect of the subject matter described in this disclosure can be implemented in a non-transitory computer-readable medium storing code for wireless communications. The code may include instructions executable by one or more processors to generate encoded pairing information associated with the light-emitting device, transmit a signal including light output modulation of the light-emitting device, the signal including the encoded pairing information, and perform, at the light-emitting device, a Bluetooth pairing procedure with a UE based on the encoded pairing information.

In some examples of the method, light-emitting devices, and non-transitory computer-readable medium described herein, the signal includes personal identification information associated with the light-emitting device and performing the Bluetooth pairing procedure with the UE may be based on the personal identification information.

In some examples of the method, light-emitting devices, and non-transitory computer-readable medium described herein, the personal identification information includes a PIN or a passkey associated with the light-emitting device.

In some examples of the method, light-emitting devices, and non-transitory computer-readable medium described herein, the signal further includes an on-off keying signal, a variable pulse position modulation signal, a color shift keying signal, or any combination thereof.

In some examples of the method, light-emitting devices, and non-transitory computer-readable medium described herein, transmitting the signal may include operations, features, means, or instructions for transmitting a unique pattern of changes in light intensity of the light output modulation to a sensor at the UE.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 illustrates an example of a signaling diagram that supports Bluetooth pairing using a light sensor.

FIG. 3 shows an example of a process flow that supports Bluetooth pairing using a light sensor.

FIG. 4 shows a block diagram of an example wireless communication device that supports Bluetooth pairing using a light sensor.

FIG. 5 shows a block diagram of an example wireless communication device that supports Bluetooth pairing using a light sensor.

FIG. 6 shows a flowchart illustrating an example process performable by or at a user equipment (UE) that supports Bluetooth pairing using a light sensor.

FIG. 7 shows a flowchart illustrating an example process performable by or at a light-emitting device that supports Bluetooth pairing using a light sensor.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to a UE and a light-emitting device that may perform a Bluetooth pairing procedure based on (such as using) information transmitted via light output from the light-emitting device. The light-emitting device may generate encoded information such as encoded pairing information associated with the light-emitting device, encoded personal identification information (such as a personal identification number (PIN) or a passkey) associated with the light-emitting device, or both. The light-emitting device may transmit the encoded information by modulating light output (such as by using techniques such as on-off keying, variable position modulation, brightness modulation, color modulation, additional or similar techniques, or any combination thereof). In some implementations, the UE may receive the encoded information via one or more sensors (such as a light intensity flux sensor, or a camera, among other examples), and may decode the encoded information to obtain pairing information, personal identification information associated with the light-emitting device, or both. After (or concurrent with) successfully completing this communication and decoding, the UE and the light-emitting device may perform the Bluetooth pairing procedure based on the pairing information, the personal identification information, or both. Thus, the UE may pair with the light-emitting device for secure communication.

Particular aspects of the subject matter described in this disclosure can be implemented to realize one or more of the following potential advantages. In some implementations, by perform pairing procedures based on information transmitted via light output from the light-emitting device, the described techniques can be used to increase security by inhibiting an unauthorized user (such as a hacker) that is attempting to connect to and control a light-emitting device (a television set, a smart light, or other light-emitting device). For example, the unauthorized user may attempt to hack or hijack pairing with one or more devices inside a home from outside a home, and the subject matter described in this disclosure can be implemented to prevent the unauthorized user from gaining unauthorized access to the one or more devices.

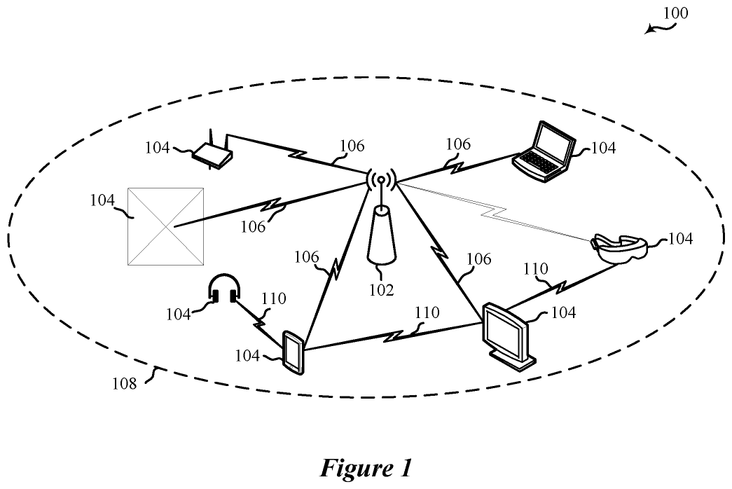

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use implementations associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

Further, as described herein, the terms “channel” and “subchannel” may be used interchangeably, and each may refer to a portion of a frequency spectrum via which communication between two or more wireless communication devices can be allocated. For example, a channel or subchannel may refer to a discrete portion (such as a discrete amount, span, range, or subset) of frequency of an operating bandwidth. A channel or subchannel may refer to a 20 MHz portion, a 40 MHz portion, an 80 MHz portion, or a 160 MHz portion, among other examples. In other words, a channel or subchannel may include one or more 20 MHz channels. A primary channel or subchannel may be understood as a portion of a frequency spectrum that includes a primary 20 MHz used for beaconing, among other (management) frame transmissions. A secondary channel or subchannel may be understood as a portion of a frequency spectrum that excludes the primary 20 MHz (or that at least excludes a main primary (M-Primary) channel). In some systems, a secondary channel or subchannel may include an opportunistic primary (O-Primary) channel. A wireless communication device may use an M-Primary channel (such as an M-Primary 20 MHz) for beaconing and/or serving legacy clients and may use an O-Primary channel (such as an O-Primary 20 MHz) for opportunistic access on one or more other channels (such as if the M-Primary channel is busy or occupied).

In some aspects, different portions of a frequency spectrum (such as a 40 MHz portion, an 80 MHz portion, or a 160 MHz portion) may be associated with multiple (20 MHz) subchannels and at least one anchor subchannel. In such aspects, an anchor subchannel may define, indicate, or identify a lowest (20 MHz) subchannel within a given portion of a frequency spectrum. For example, a first anchor subchannel may define, indicate, or identify a lowest 20 MHz subchannel within a secondary 40 MHz bandwidth, a second anchor subchannel may define, indicate, or identify a lowest 20 MHz subchannel within a secondary 80 MHz bandwidth, and a third anchor subchannel may define, indicate, or identify a lowest 20 MHz subchannel within a secondary 160 MHz bandwidth. In some aspects, a wireless communication device may use an anchor subchannel as an O-Primary channel.

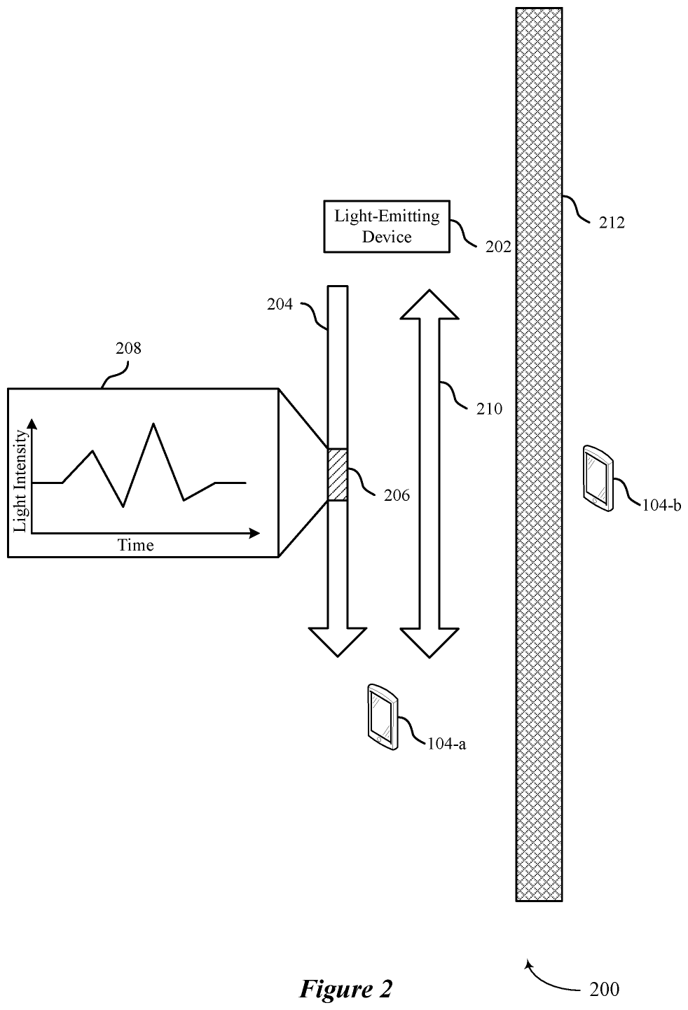

FIG. 2 shows an example of a signaling diagram 200 that supports Bluetooth pairing using a light sensor. In some implementations, the signaling diagram 200 may implement or be implemented by aspects of the wireless communication network 100. For example, the signaling diagram 200 may include one or more STAs 104 (such as a STA 104-a, a STA 104-b), which may be examples of the corresponding devices as described herein (such as with reference to FIG. 1). The STA 104-a and the STA 104-b may each be an example of a user equipment (such as a smart phone, laptop, or similar devices). The STA 104-a may be an example of a client device controlled by a user or owner of the light-emitting device 202. The STA 104-b may be an example of a device controlled by an unauthorized user (such as a hacker). The signaling diagram 200 may further include a light-emitting device 202. The light-emitting device 202 may be an example of a smart light, or a STA 104, or any device that may emit light (such as a television set, a smart light, a climate control unit, a vehicle, or similar devices). The STA 104-a, the STA 104-b, and light-emitting device 202 may be capable of performing pairing procedures (such as Bluetooth Low Energy (BLE) pairing procedures).

In some wireless communication networks, the STA 104-a may perform a pairing procedure (such as a Bluetooth pairing procedure) to connect to the light-emitting device 202. In some implementations, the light-emitting device 202 may lack a display, keyboard, or other input and output components to facilitate pairing. Thus, the pairing procedure may correspond to a relatively simple pairing method (such as “Just Works” BLE pairing). Such a simple pairing method may not rely on authentication procedures, and may be performable via any wireless communication (such as regardless of line-of-sight, or distance between devices). As such, the unauthorized user may cause the STA 104-b to perform a similar pairing procedure to connect to the light-emitting device 202, even if the light-emitting device 202 and the STA 104-b are separated by a barrier 212 (such as a wall). If successful, the STA 104-b may be capable of controlling the light-emitting device 202 (for example, from outside of the home of the authorized users). For instance, if the light-emitting device 202 operates according to a user application, then anyone who has the mobile application of the light-emitting device 202 (such as an application from a same manufacturer) may be able to easily pair of the light-emitting device 202, and control the light-emitting device (such as a hacker outside of a house wall may connect to a BLE smart light and cause problems by controlling the light inside the home). Such security breaches may present a security risk, increased access for bad actors to a home or other organization, hampering of security and safety of owners and authorized users, and diminishing the user experience. Techniques described herein support authenticated users to connect to light-emitting devices, while restricting unauthorized users.

In some implementations of the present disclosure, the light-emitting device 202 may generate a Bluetooth pairing key, pairing information, or both, and may use visible light modulation techniques to pair with an authorized device such as the STA 104-a. The light-emitting device 202 may be able to generate and modulate a light output. For example, a light-emitting device 202 may include one or more light-emitting diodes (LEDs). Thus, the light-emitting device 202 may encode the Bluetooth pairing key, the pairing information, or both using visible light modulation techniques such as On-Off Keying, Variable Pulse Position Modulation, Color Shift Keying, or any combination thereof. The light-emitting device 202 may use the one or more light outputs (such as LEDs) and any combination of the light modulation techniques to transmit encoded information 206 via a light signal 204. The light-emitting device 202 may include components and firmware that enable it to generate the encoded information 206 and to produce the light signal 204.

Using the light modulation techniques, the light-emitting device 202 may produce the light signal 204 represented by a graph 208 including an x-axis representing time and a y-axis representing light properties such as light intensity, color, pulse, or any combination thereof. The light-emitting device 202 may thus produce the light signal 204 with fluctuations in light properties. For example, the light-emitting device 202 may select a unique pattern of changes in light intensity or changes in color, and accordingly may produce (may transmit) the light signal 204 based on the unique pattern.

In some implementations, the STA 104-a may include a light intensity sensor (such as a luminous flux sensor or a camera). The light intensity sensor may be capable of detecting (or reading) the encoded information 206 which may include a Bluetooth address associated with the light-emitting device 202, a luminous flux encoded PIN, the Bluetooth pairing key, the encoded pairing information associated with the light-emitting device 202, or any combination thereof. The STA 104-a may decode any combination of the encoded information 206 using the light intensity sensor, and may use the decoded information (such as a PIN or passkey) to securely pair with the light-emitting device 202. In some implementations, the STA 104-a may receive the encoded information 206 via visible light communication (VLC). For example, the VLC may function as an out-of-band communication link to exchange Bluetooth authentication data to establish a Bluetooth communication link 210 (such as an authenticated and cryptographically protected in-band Bluetooth communication link) between the light-emitting device 202 and the STA 104-a.

In some implementations, the STA 104-a may be in relatively close proximity to the light-emitting device 202 (such as within 2-4 feet) to receive the encoded information 206. Additionally, or alternatively, there may be a direct line of sight between the STA 104-a and the light-emitting device 202 such that the STA 104-a may receive the encoded information 206. Thus, the STA 104-b (or any device utilized by an unauthorized person) may be unable to perform an unauthorized pairing procedure with the light-emitting device 202 (for example, because the unauthorized user may be located too far away from the light-emitting device 202 for successful pairing using techniques described herein, or because the unauthorized user is located outside of a structure such as on the other side of the barrier 212, and may therefore be unable to perform successful pairing via the light modulation techniques described herein.

In some implementations, the light-emitting device 202 may be an example of any Bluetooth (such as BLE) enabled device (such as any Smart Light in a household). The light-emitting device 202 may be an example of an automotive vehicle, such as a motorcycle or car. For example, the STA 104-a may pair with the vehicle equipped with one or more LEDs (such as LED headlights or indicators) to obtain information associated with the vehicle (such as drive information) or to lock or unlock the vehicle. In some implementations, the light-emitting device 202 may refrain from displaying a PIN for the Bluetooth pairing procedure, and instead (or in addition to) may transmit encoded personal identification information via light output as described herein. In some implementations, the light-emitting device 202 may be an example of any device equipped with components (such as LEDs) to perform VLC, such an LED television set which can modulate its brightness to securely pair with BLE devices. In such examples, the STA 104-a may pair with the light-emitting device 202 via light signaling and may not receive a notification to match and enter a PIN displayed on a screen of the light-emitting device 202 (such as the light-emitting device 202 may modulate its brightness to securely pair with the STA 104-a without the user being notified to match and enter the PIN displayed on the screen).

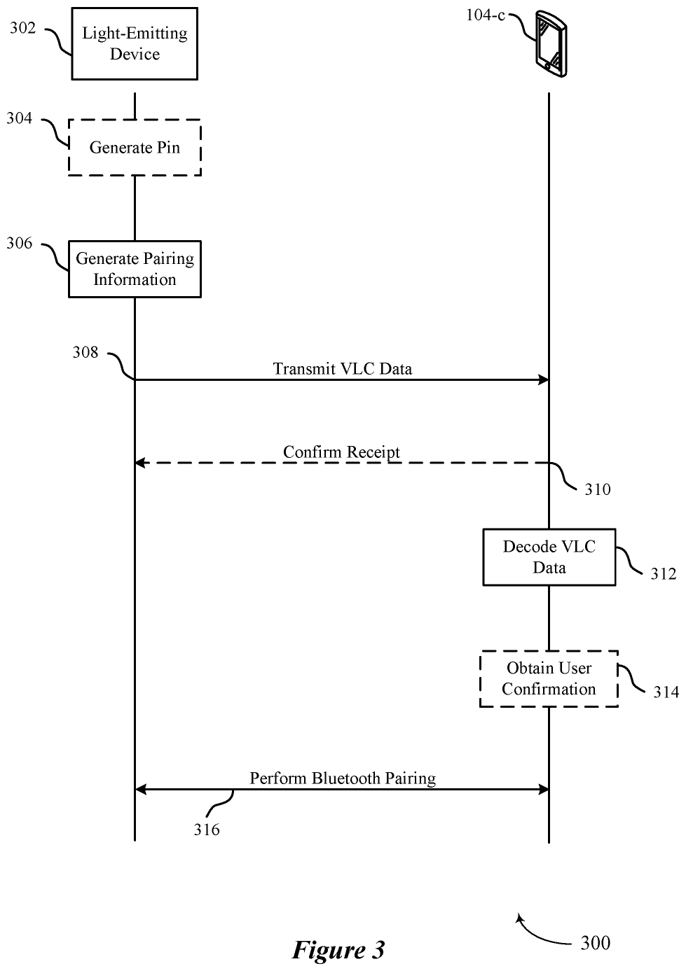

FIG. 3 shows an example of a process flow 300 that supports Bluetooth pairing using a light sensor. The process flow 300 includes a STA 104-c and a light-emitting device 302, which may be examples of the corresponding devices as described with respect to FIGS. 1 and 2. The STA 104-c may be an example of a user equipment such as a smart phone, a laptop, or a similar device. In the following description of the process flow 300, the operations between STA 104-c and a light-emitting device 302 may be performed in a different order than the example order shown. Some operations also may be omitted from the process flow 300, and other operations may be added to the process flow 300. Further, although some operations or signaling may be shown to occur at different times for discussion purposes, these operations may actually occur at the same time. For example, as described with reference to the process flow 300, the light-emitting device 302 and the STA 104-c may perform a pairing procedure (such as using BLE). The light-emitting device 302 may generate a PIN and transfer it to the STA 104-c via light modulation (such as out-of-band VLC). The STA 104-c may use the received PIN to authenticate and finish the pairing process.

At 304, the light-emitting device 302 may generate personal identification information associated with the light-emitting device. The personal identification information may include a PIN or a passkey associated with the light-emitting device 302. At 306, the light-emitting device 302 may generate encoded pairing information associated with the light-emitting device 302. In some implementations, the light-emitting device may be an example of a Bluetooth low energy smart light, a light-emitting diode (LED) television set, or an LED equipped vehicle.

At 308, the STA 104-c may receive, via a sensor at the STA 104-c, a signal including light output modulation of the light-emitting device 302. The signal may include the encoded pairing information, the personal identification information, or both. The signal may be conveyed using (or may be defined as) an on-off keying signal, a variable pulse position modulation signal, a color shift keying signal, or any combination thereof. In some implementations, the STA 104-c may detect a unique pattern of changes in light intensity of the light output modulation via the sensor at the UE. The sensor at the UE may include a light intensity flux sensor, a camera, or both. For example, at 308, the light-emitting device may utilize one or more LEDs to generate (transmit) the light-modulation signal, which may include (or may be) the encoded pairing information. The STA 104-c may detect the modulated light, and may therefore receive the transmitted pairing information.

At 310, the STA 104-c may optionally transmit a confirmation indication to the light-emitting device 302. The confirmation indication may indicate to the light-emitting device 302 that the STA 104-c received the signal. The confirmation indication may be transmitted via light or via wireless signaling, among other examples.

At 312, the STA 104-c may decode the encoded pairing information of the signal to obtain pairing information associated with the light-emitting device 302.

At 314, the STA 104-c may obtain a user confirmation. The STA 104-c may optionally receive a confirmation message indicating successful receipt of the encoded pairing information. In some implementations, the STA 104-c may successfully decode the encoded pairing information of the signal to obtain the pairing information. In some implementations, the STA 104-c may receive the confirmation message from a user interface of the STA 104-c, from an internal module, or any combination thereof. For example, the user may issue the confirmation message after being prompted to begin a pairing procedure (such as a Bluetooth pairing procedure).

At 316, the STA 104-c may perform a Bluetooth pairing procedure with the light-emitting device based on the pairing information associated with the light-emitting device 302, the personal identification information associated with the light-emitting device 302, or both. In some implementations, the STA 104-c may perform the first Bluetooth pairing procedure based on the confirmation message, the confirmation indication, or both. Similarly, the light-emitting device 302 may perform the Bluetooth pairing procedure with the STA 104-c based on the pairing information associated with the light-emitting device 302, the personal identification information associated with the light-emitting device 302, or both.

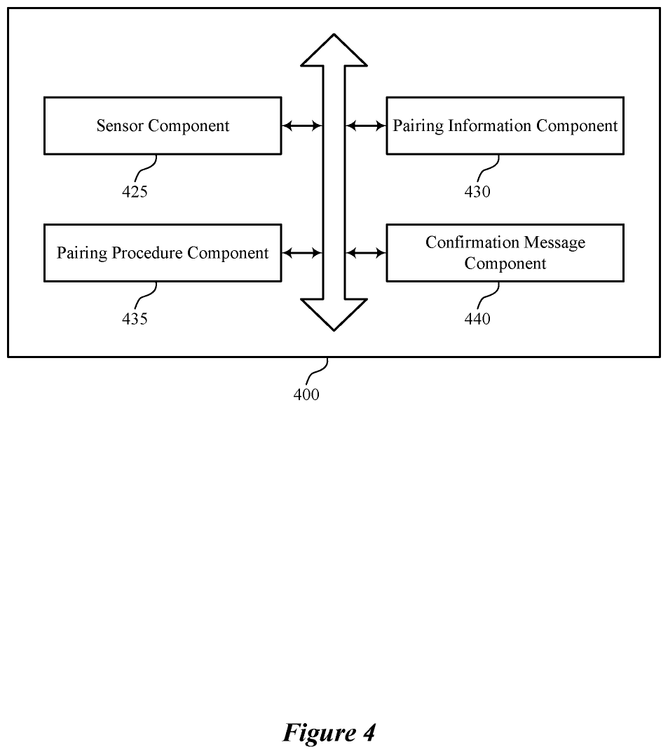

FIG. 4 shows a block diagram of a device 400 that supports Bluetooth pairing using a light sensor. The device 400 may be an example of aspects of a STA 104 as described with reference to FIGS. 1 through 3. The device 400, or various components thereof, may be an example of means for performing various aspects of Bluetooth pairing using a light sensor as described herein. For example, the device 400 may include a sensor component 425, a pairing information component 430, a pairing procedure component 435, a confirmation message component 440, or any combination thereof. Each of these components, or components or subcomponents thereof (such as one or more processors such as processor circuitry, such as one or more memories such as memory circuitry), may communicate, directly or indirectly, with one another (such as via one or more buses). In some implementations, the device 400 may be a wireless device (such as a smartphone).

The wireless communication device 400 may support wireless communications in accordance with examples as disclosed herein. The sensor component 425 is configurable or configured to receive, via a sensor at the UE, a signal including light output modulation of a light-emitting device, the signal including encoded pairing information. The pairing information component 430 is configurable or configured to decode the encoded pairing information of the signal to obtain pairing information associated with the light-emitting device. The pairing procedure component 435 is configurable or configured to perform, at the UE, a Bluetooth pairing procedure with the light-emitting device based on the pairing information.

In some implementations, the signal includes personal identification information associated with the light-emitting device. In some implementations, performing the Bluetooth pairing procedure with the light-emitting device is based on the personal identification information.

In some implementations, the personal identification information includes a personal identification number (PIN) or a passkey associated with the light-emitting device.

In some implementations, the signal further includes an on-off keying signal, a variable pulse position modulation signal, a color shift keying signal, or any combination thereof.

In some implementations, to support receiving the signal, the sensor component 425 is configurable or configured to detect a unique pattern of changes in light intensity of the light output modulation via the sensor at the UE.

In some implementations, the sensor includes a light intensity flux sensor, a camera, or both.

In some implementations, the confirmation message component 440 is configurable or configured to receive, a confirmation message indicating successful receipt of the encoded pairing information, where performing the Bluetooth pairing procedure is based on the confirmation message.

In some implementations, the light-emitting device includes a Bluetooth low energy smart light, a light-emitting diode (LED) television set, or an LED equipped vehicle.

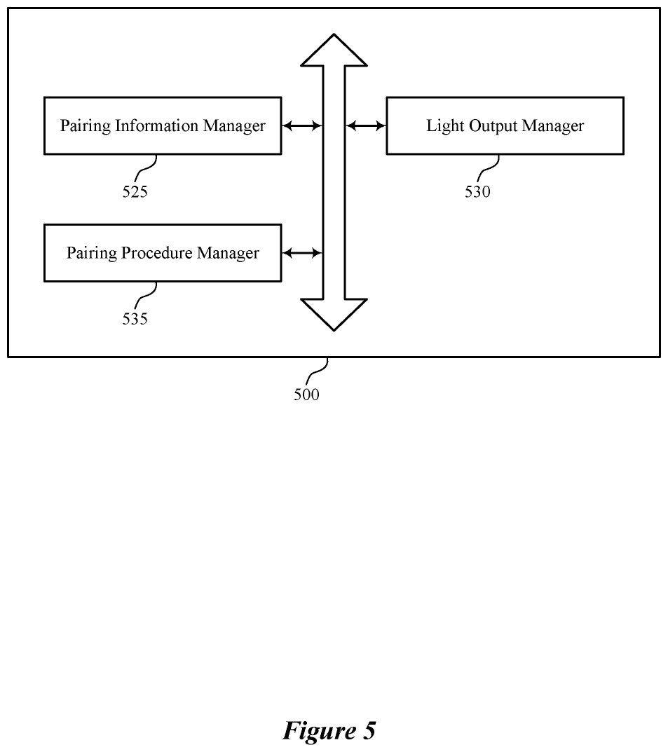

FIG. 5 shows a block diagram of a device 500 that supports Bluetooth pairing using a light sensor. The device 500 may be an example of aspects of a device, such as a light-emitting device as described with reference to FIGS. 1 through 3. The device 500, or various components thereof, may be an example of means for performing various aspects of Bluetooth pairing using a light sensor as described herein. For example, the device 500 may include a pairing information manager 525, a light output manager 530, a pairing procedure manager 535, or any combination thereof. Each of these components, or components or subcomponents thereof (such as one or more processors such as processor circuitry, such as one or more memories such as memory circuitry), may communicate, directly or indirectly, with one another (such as via one or more buses). In some implementations, the device 500 may be a light-emitting device.

The wireless communication device 500 may support wireless communications in accordance with examples as disclosed herein. The pairing information manager 525 is configurable or configured to generate encoded pairing information associated with the light-emitting device. The light output manager 530 is configurable or configured to transmit a signal including light output modulation of the light-emitting device, the signal including the encoded pairing information. The pairing procedure manager 535 is configurable or configured to perform, at the light-emitting device, a Bluetooth pairing procedure with a UE based on the encoded pairing information.

In some implementations, the signal includes personal identification information associated with the light-emitting device. In some implementations, performing the Bluetooth pairing procedure with the UE is based on the personal identification information.

In some implementations, the personal identification information includes a personal identification number (PIN) or a passkey associated with the light-emitting device.

In some implementations, the signal further includes an on-off keying signal, a variable pulse position modulation signal, a color shift keying signal, or any combination thereof.

In some implementations, to support transmitting the signal, the light output manager 530 is configurable or configured to transmit a unique pattern of changes in light intensity of the light output modulation to a sensor at the UE.

In some implementations, a sensor at the UE includes a light intensity flux sensor, a camera, or both.

In some implementations, the light-emitting device includes a Bluetooth low energy smart light, a light-emitting diode (LED) television set, or an LED equipped vehicle.

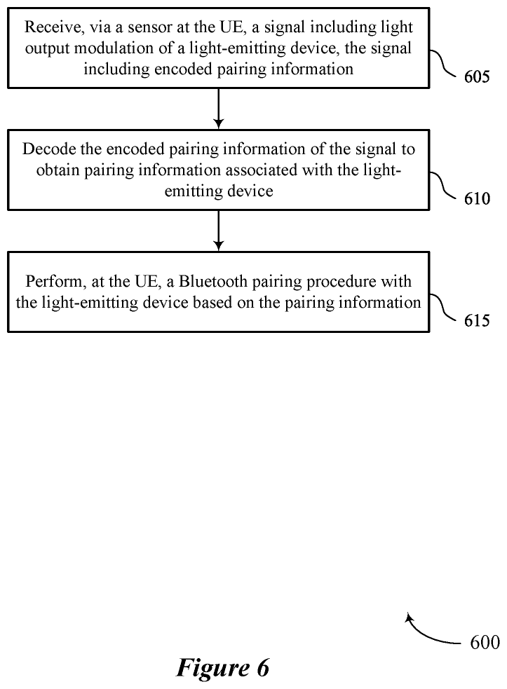

FIG. 6 shows a flowchart illustrating a method 600 that supports Bluetooth pairing using a light sensor. The operations of the method 600 may be implemented by a device, such as a STA 104, or its components as described herein. For example, the operations of the method 600 may be performed by a device as described with reference to FIGS. 1 through 4. In some implementations, a device may execute a set of instructions to control the functional elements of the device to perform the described functions. Additionally, or alternatively, the device may perform aspects of the described functions using special-purpose hardware. In some implementations, the device described with reference to the method 600 may be a wireless device (such as a smartphone).

At 605, the method may include receiving, via a sensor at the UE, a signal including light output modulation of a light-emitting device, the signal including encoded pairing information. The operations of block 605 may be performed in accordance with examples as disclosed herein. In some implementations, aspects of the operations of 605 may be performed by a sensor component 425 as described with reference to FIG. 4.

At 610, the method may include decoding the encoded pairing information of the signal to obtain pairing information associated with the light-emitting device. The operations of block 610 may be performed in accordance with examples as disclosed herein. In some implementations, aspects of the operations of 610 may be performed by a pairing information component 430 as described with reference to FIG. 4.

At 615, the method may include performing, at the UE, a Bluetooth pairing procedure with the light-emitting device based on the pairing information. The operations of block 615 may be performed in accordance with examples as disclosed herein. In some implementations, aspects of the operations of 615 may be performed by a pairing procedure component 435 as described with reference to FIG. 4.

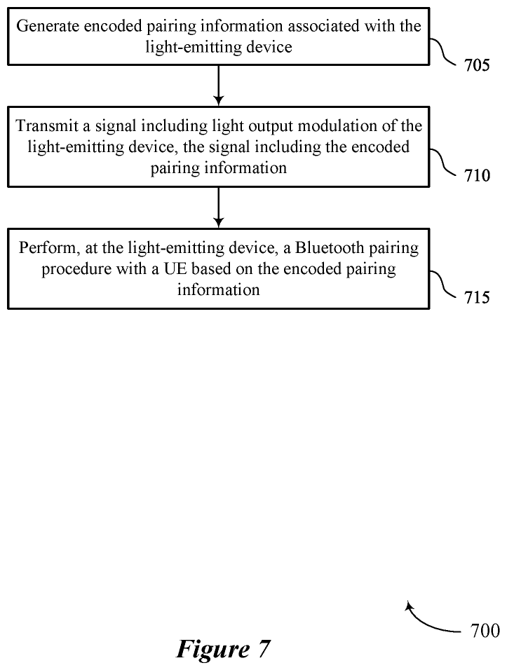

FIG. 7 shows a flowchart illustrating a method 700 that supports Bluetooth pairing using a light sensor. The operations of the method 700 may be implemented by a device or its components as described herein. For example, the operations of the method 700 may be performed by a device as described with reference to FIGS. 1 through 3 and 5. In some implementations, a device may execute a set of instructions to control the functional elements of the device to perform the described functions. Additionally, or alternatively, the device may perform aspects of the described functions using special-purpose hardware. In some implementations, the device described with reference to the method 700 may be a light-emitting device.

At 705, the method may include generating encoded pairing information associated with the light-emitting device. The operations of block 705 may be performed in accordance with examples as disclosed herein. In some implementations, aspects of the operations of 705 may be performed by a pairing information manager 525 as described with reference to FIG. 5.

At 710, the method may include transmitting a signal including light output modulation of the light-emitting device, the signal including the encoded pairing information. The operations of block 710 may be performed in accordance with examples as disclosed herein. In some implementations, aspects of the operations of 710 may be performed by a light output manager 530 as described with reference to FIG. 5.

At 715, the method may include performing, at the light-emitting device, a Bluetooth pairing procedure with a UE based on the encoded pairing information. The operations of block 715 may be performed in accordance with examples as disclosed herein. In some implementations, aspects of the operations of 715 may be performed by a pairing procedure manager 535 as described with reference to FIG. 5.

Implementation examples are described in the following numbered clauses:

The following provides an overview of aspects of the present disclosure:

Aspect 1: A method for wireless communications at a UE, including: receiving, via a sensor at the UE, a signal including light output modulation of a light-emitting device, the signal including encoded pairing information; decoding the encoded pairing information of the signal to obtain pairing information associated with the light-emitting device; and performing, at the UE, a Bluetooth pairing procedure with the light-emitting device based at least in part on the pairing information.

Aspect 2: The method of aspect 1, where the signal includes personal identification information associated with the light-emitting device, and performing the Bluetooth pairing procedure with the light-emitting device is based at least in part on the personal identification information.

Aspect 3: The method of aspect 2, where the personal identification information includes a personal identification number (PIN) or a passkey associated with the light emitting device.

Aspect 4: The method of any of aspects 1-3, where the signal further includes an on-off keying signal, a variable pulse position modulation signal, a color shift keying signal, or any combination thereof.

Aspect 5: The method of any of aspects 1-4, where receiving the signal includes: detecting a unique pattern of changes in light intensity of the light output modulation via the sensor at the UE.

Aspect 6: The method of any of aspects 1-5, where the sensor includes a light intensity flux sensor, a camera, or both.

Aspect 7: The method of any of aspects 1-6, further including: receiving, a confirmation message indicating successful receipt of the encoded pairing information, where performing the Bluetooth pairing procedure is based at least in part on the confirmation message.

Aspect 8: The method of any of aspects 1-7, where the light-emitting device includes a Bluetooth low energy smart light, a light-emitting diode (LED) television set, or an LED equipped vehicle.

Aspect 9: A method for wireless communications at a light-emitting device, including: generating encoded pairing information associated with the light-emitting device; transmitting a signal including light output modulation of the light-emitting device, the signal including the encoded pairing information; and performing, at the light-emitting device, a Bluetooth pairing procedure with a UE based at least in part on the encoded pairing information.

Aspect 10: The method of aspect 9, where the signal includes personal identification information associated with the light-emitting device, and performing the Bluetooth pairing procedure with the UE is based at least in part on the personal identification information.

Aspect 11: The method of aspect 10, where the personal identification information includes a personal identification number (PIN) or a passkey associated with the light-emitting device.

Aspect 12: The method of any of aspects 9-11, where the signal further includes an on-off keying signal, a variable pulse position modulation signal, a color shift keying signal, or any combination thereof.

Aspect 13: The method of any of aspects 9-12, where transmitting the signal includes: transmitting a unique pattern of changes in light intensity of the light output modulation to a sensor at the UE.

Aspect 14: The method of any of aspects 9-13, where a sensor at the UE includes a light intensity flux sensor, a camera, or both.

Aspect 15: The method of any of aspects 9-14, where the light-emitting device includes a Bluetooth low energy smart light, a light-emitting diode (LED) television set, or an LED equipped vehicle.

Aspect 16: A UE for wireless communications, including one or more memories storing processor-executable code, and one or more processors coupled with the one or more memories and individually or collectively operable to execute the code to cause the UE to perform a method of any of aspects 1-8.

Aspect 17: A UE for wireless communications, including at least one means for performing a method of any of aspects 1-8.

Aspect 18: A non-transitory computer-readable medium storing code for wireless communications, the code including instructions executable by one or more processors to perform a method of any of aspects 1-8.

Aspect 19: A light-emitting device for wireless communications, including one or more memories storing processor-executable code, and one or more processors coupled with the one or more memories and individually or collectively operable to execute the code to cause the light-emitting device to perform a method of any of aspects 9-15.

Aspect 20: A light-emitting device for wireless communications, including at least one means for performing a method of any of aspects 9-15.

Aspect 21: A non-transitory computer-readable medium storing code for wireless communications, the code including instructions executable by one or more processors to perform a method of any of aspects 9-15.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A user equipment (UE), comprising:
a processing system that includes processor circuitry and memory circuitry that stores code, the processing system configured to cause the UE to:
receive, via a sensor at the UE, a signal comprising light output modulation of a light-emitting device, the signal comprising encoded pairing information;
decode the encoded pairing information of the signal to obtain pairing information associated with the light-emitting device; and
perform, at the UE, a Bluetooth pairing procedure with the light-emitting device based at least in part on the pairing information.

2. The UE of claim 1, wherein:
the signal comprises personal identification information associated with the light-emitting device, and
performing the Bluetooth pairing procedure with the light-emitting device is based at least in part on the personal identification information.

3. The UE of claim 2, wherein the personal identification information comprises a personal identification number (PIN) or a passkey associated with the light-emitting device.

4. The UE of claim 1, wherein the signal further comprises an on-off keying signal, a variable pulse position modulation signal, a color shift keying signal, or any combination thereof.

5. The UE of claim 1, wherein, to receive the signal, the processing system is configured to cause the UE to:
detect a unique pattern of changes in light intensity of the light output modulation via the sensor at the UE.

6. The UE of claim 1, wherein the sensor comprises a light intensity flux sensor, a camera, or both.

7. The UE of claim 1, wherein the processing system is further configured to cause the UE to:
receive, a confirmation message indicating successful receipt of the encoded pairing information, wherein performing the Bluetooth pairing procedure is based at least in part on the confirmation message.

8. The UE of claim 1, wherein the light-emitting device comprises a Bluetooth low energy smart light, a light-emitting diode (LED) television set, or an LED equipped vehicle.

9. A light-emitting device, comprising:
a processing system that includes processor circuitry and memory circuitry that stores code, the processing system configured to cause the light-emitting device to:
generate encoded pairing information associated with the light-emitting device;
transmit a signal comprising light output modulation of the light-emitting device, the signal comprising the encoded pairing information; and
perform, at the light-emitting device, a Bluetooth pairing procedure with a user equipment (UE) based at least in part on the encoded pairing information.

10. The light-emitting device of claim 9, wherein:
the signal comprises personal identification information associated with the light-emitting device, and
performing the Bluetooth pairing procedure with the UE is based at least in part on the personal identification information.

11. The light-emitting device of claim 10, wherein the personal identification information comprises a personal identification number (PIN) or a passkey associated with the light-emitting device.

12. The light-emitting device of claim 9, wherein the signal further comprises an on-off keying signal, a variable pulse position modulation signal, a color shift keying signal, or any combination thereof.

13. The light-emitting device of claim 9, wherein, to transmit the signal, the processing system is configured to cause the light-emitting device to:
transmit a unique pattern of changes in light intensity of the light output modulation to a sensor at the UE.

14. The light-emitting device of claim 9, wherein a sensor at the UE comprises a light intensity flux sensor, a camera, or both.

15. The light-emitting device of claim 9, wherein the light-emitting device comprises a Bluetooth low energy smart light, a light-emitting diode (LED) television set, or an LED equipped vehicle.

16. A method for wireless communications at a user equipment (UE), comprising:
receiving, via a sensor at the UE, a signal comprising light output modulation of a light-emitting device, the signal comprising encoded pairing information;
decoding the encoded pairing information of the signal to obtain pairing information associated with the light-emitting device; and
performing, at the UE, a Bluetooth pairing procedure with the light-emitting device based at least in part on the pairing information.

17. The method of claim 16, wherein:
the signal comprises personal identification information associated with the light-emitting device, and
performing the Bluetooth pairing procedure with the light-emitting device is based at least in part on the personal identification information.

18. The method of claim 17, wherein the personal identification information comprises a personal identification number (PIN) or a passkey associated with the light-emitting device.

19. The method of claim 16, wherein the signal further comprises an on-off keying signal, a variable pulse position modulation signal, a color shift keying signal, or any combination thereof.

20. The method of claim 16, wherein receiving the signal comprises:
detecting a unique pattern of changes in light intensity of the light output modulation via the sensor at the UE.

21. The method of claim 16, wherein the sensor comprises a light intensity flux sensor, a camera, or both.

22. The method of claim 16, further comprising:
receiving, a confirmation message indicating successful receipt of the encoded pairing information, wherein performing the Bluetooth pairing procedure is based at least in part on the confirmation message.

23. The method of claim 16, wherein the light-emitting device comprises a Bluetooth low energy smart light, a light-emitting diode (LED) television set, or an LED equipped vehicle.

24. A method for wireless communications at a light-emitting device, comprising:
generating encoded pairing information associated with the light-emitting device;
transmitting a signal comprising light output modulation of the light-emitting device, the signal comprising the encoded pairing information; and
performing, at the light-emitting device, a Bluetooth pairing procedure with a user equipment (UE) based at least in part on the encoded pairing information.

25. The method of claim 24, wherein:
the signal comprises personal identification information associated with the light-emitting device, and
performing the Bluetooth pairing procedure with the UE is based at least in part on the personal identification information.

26. The method of claim 25, wherein the personal identification information comprises a personal identification number (PIN) or a passkey associated with the light-emitting device.

27. The method of claim 24, wherein the signal further comprises an on-off keying signal, a variable pulse position modulation signal, a color shift keying signal, or any combination thereof.

28. The method of claim 24, wherein transmitting the signal comprises:
transmitting a unique pattern of changes in light intensity of the light output modulation to a sensor at the UE.

29. The method of claim 24, wherein a sensor at the UE comprises a light intensity flux sensor, a camera, or both.

30. The method of claim 24, wherein the light-emitting device comprises a Bluetooth low energy smart light, a light-emitting diode (LED) television set, or an LED equipped vehicle.
